(19) United States
(12) Patent Application Publication
(10) Pub. No.: US 2004/0012576 A1
(43) Pub. Date: Jan. 22, 2004

(54) Digital image display method and system

(76) Inventor: Robert Cazier, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/197,345

(22) Filed: Jul. 16, 2002

(51) Int. Cl. G09G 5/00

(52) U.S. Cl. 345/204

(57) ABSTRACT

An image display system and associated method displays an image for a period dependent on the evaluated complexity of the image. The invention provides the viewer a suitable period during which to examine images in applications involving the automatic displaying of images.

### FIELD OF THE INVENTION

The present invention relates generally to digital imaging and more specifically to methods and systems for displaying digital images.

### BACKGROUND OF THE INVENTION

A common application for digital imaging devices such as digital cameras and scanners is the displaying of images on a computer monitor, television, or projector screen. Often, the images are shown in sequence as a slideshow. In some applications, the period for which each image is displayed is controlled manually. In other applications, the sequence of images may be shown automatically, each image being displayed for a fixed period. Unfortunately, images vary in complexity. Therefore, a fixed period that is suitable for a simple image may be too brief for a more complex image. It is thus apparent that there is a need in the art for an improved digital image display method and system.

### SUMMARY OF THE INVENTION

A method for displaying an image is provided. An image display system for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a functional block diagram of an image display system in accordance with an illustrative embodiment of the invention.

FIGS. 2A and 2B are illustrations showing examples of images of low and high complexity, respectively, in accordance with an illustrative embodiment of the invention.

FIG. 3 is a flowchart of the operation of the image display system shown in FIG. 1 in accordance with an illustrative embodiment of the invention.

### DETAILED DESCRIPTION OF THE INVENTION

In applications in which a sequence of images (e.g., a slideshow) is displayed automatically, viewing may be improved by making the period for which each image is displayed dependent on the complexity of that image. For example, a photograph of a group of people may be displayed for a longer period than a simple photograph of a single object. The extra time for the more complex image allows the viewer an opportunity to view each portion of the complex image (e.g., the face of each person in the group photo) to his satisfaction. Any method for evaluating the complexity of an image may be used in implementing the invention. Some examples of techniques for evaluating image complexity are discussed in a later portion of this detailed description. Throughout this description, “evaluating” the complexity of an image means any method for associating a complexity value or category with that image. The complexity of an image may be evaluated, for example, by measurement, estimation, the use of deterministic side information, or any other suitable method.

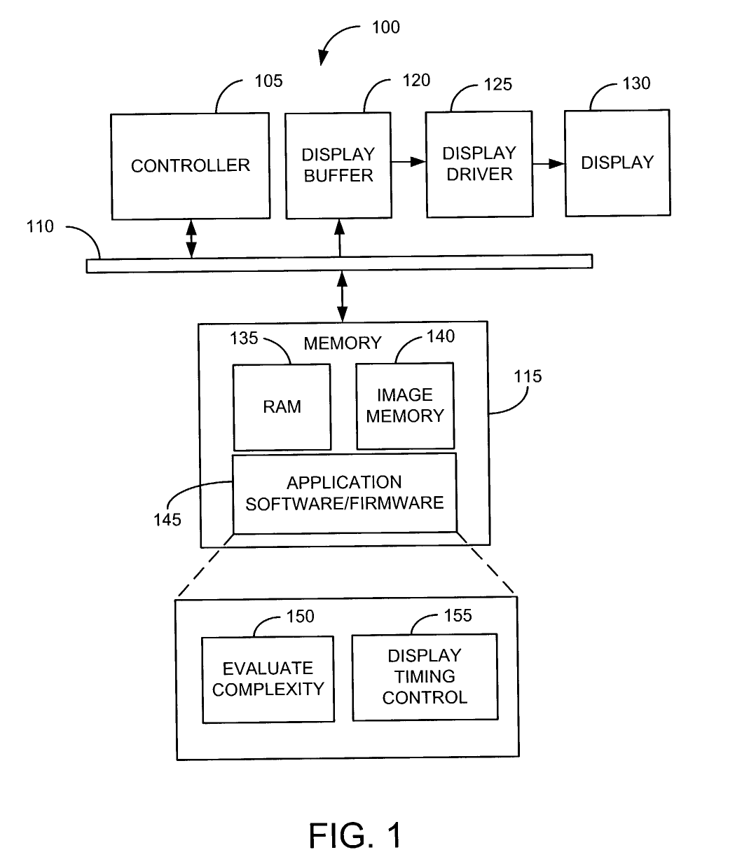

FIG. 1 is a functional block diagram of an image display system 100 in accordance with an illustrative embodiment of the invention. In FIG. 1, controller 105 communicates over data bus 110 with memory 115 and display buffer 120. Display buffer 120 outputs image data to display driver 125, which controls display 130. Memory 115 further comprises random access memory (RAM) 135, image memory 140, and application software/firmware 145. Application software/firmware 145 further comprises Module “Evaluate Complexity” (150) and Module “Display Timing Control” (155). Module “Evaluate Complexity” 150 evaluates the complexity of an image and determines, based on its complexity, how long the image should be displayed. Module “Display Timing Control” 155 controls the displaying of images according to the period determined by Module “Evaluate Complexity” 150.

Controller 105 may, in a typical implementation, be a microprocessor or similar device. Image memory 140 may be of either the fixed or removable type (e.g., a compact flash card). Although FIG. 1 includes, by way of illustration, an active display 130 such as a CRT, the invention may be implemented just as readily in an image display system involving projection of images onto a passive screen (e.g., a front-projection system).

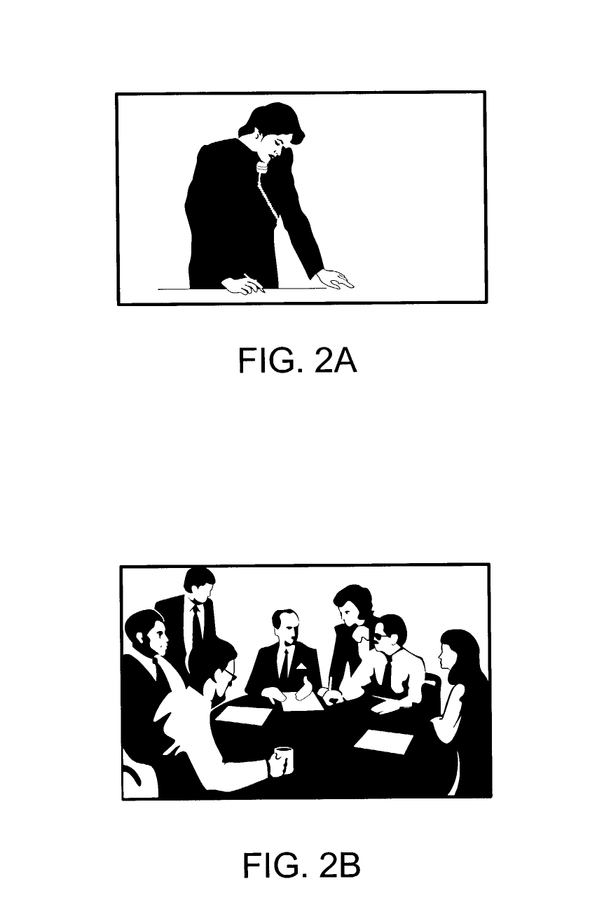

FIGS. 2A and 2B are illustrations showing examples of images of low and high complexity, respectively, in accordance with an illustrative embodiment of the invention. In FIG. 2A, a single person is depicted in front of a plain background. In FIG. 2B, seven people are depicted meeting around a conference table. The image in FIG. 2B may be termed more complex than that in FIG. 2A because a viewer would likely desire more time to examine FIG. 2B than FIG. 2A, especially if the viewer were attempting to identify the people in the image.

The complexity of an image may be evaluated in a variety of ways that are well known in the art. Although several examples are discussed in this description, the invention may be implemented using any method of evaluating image complexity.

One method of evaluating image complexity involves examining the size of the compressed data file containing the digital image. Digital images are commonly stored in compressed form such as the popular Joint Photographic Experts Group (JPEG) format. Since compression algorithms exploit the inherent redundancy in an image, a more complex image results in a larger compressed file for a given image resolution than a simpler image. Therefore, examining the size of the compressed data file is a viable method for evaluating image complexity.

Another method for evaluating the complexity of an image is to detect and count objects or persons (features) in the image. Such methods have found application in, for example, manufacturing quality control, intelligence, the armed forces, and law enforcement. Methods for detecting human faces are disclosed, for example, in U.S. Pat. No. 6,184,926 to Khosravi et al. and U.S. Pat. No. 5,164,992 to Turk et al. Such a method may be used, for example, to assign a relatively higher complexity score to FIG. 2B than to FIG. 2A.

Yet another approach for evaluating the complexity of an image involves examining the frequency content of the image. Significant high-frequency content generally indicates a more complex image than one having little high-frequency content. For example, an image with numerous objects or sharply defined edges will have more high-frequency content than an image without such features. One well-known method for examining the frequency content of an image is to compute a frequency-domain transform of the image such as the two-dimensional Fast Fourier Transform (2-D FFT) or two-dimensional Discrete Cosine Transform (2-D DCT). In one implementation of this method, a range of discrete frequency components (bins) in the high-frequency range may be summed to measure high-frequency energy and to compute a complexity score for the image. In an alternative implementation, computing a 2-D FFT or DCT is not necessary. Instead, a relatively simple two-dimensional digital high-pass filter may be applied to the image to measure its high-frequency content without the additional processing involved in computing a full 2-D FFT or 2-D DCT.

Still another approach to evaluating the complexity of an image involves detecting edges and contours within the image. Such an approach may, in some cases, be part of a method for identifying objects or persons. A high occurrence of edges, whether the image depicts recognizable objects or an abstract pattern, generally indicates greater complexity than a relatively low occurrence of edges. Edge detection algorithms are well known in the image processing art. One example is disclosed in U.S. Pat. No. 5,719,958 to Wober et al.

Another method for evaluating the complexity of an image is based on the assumption that an image with a wide distribution of colors is more complex than one containing a more narrow distribution of colors. In a practical implementation, a histogram (a table containing the relative frequency of occurrence of each possible color) may be constructed and examined. From such a histogram, it may be readily determined whether the image has a broad or a narrow color distribution. In a simpler implementation, the histogram need only contain a binary value indicating whether a particular color occurs in the image or not. Summing across all bins of the histogram provides a count of the total number of unique colors occurring in the image. This count may then be compared with that of other images or with a threshold to assign a complexity score.

Yet another method for evaluating the complexity of an image is to examine its associated file name. Sometimes users give image files descriptive titles such as “Group Shot of Office Staffjpg”. Parsing the file name and searching for one or more of a specific list of words may provide a useful indicator of complexity in some cases. In the foregoing example, the words “group,” “office,” and “staff” all indicate a possibly complex photograph containing multiple objects or people.

Instead of measuring or estimating the complexity of an image, the complexity of the image may be determined directly from side information associated with the image. For example, the creator of the image may automatically or manually associate a tag with the image indicating its complexity. Such a tag may be embedded in the image file itself. Complexity may, for example, be represented by a numerical value within a predetermined range or by a coding scheme indicating a complexity category such as “low,” “medium,” or “high.”

The foregoing or other methods for evaluating image complexity may be combined and their individual results correlated to obtain a composite evaluation of complexity.

A display period may be derived from the evaluated complexity in a variety of ways. For example, a complexity score may be assigned based on the applicable complexity measure, and a display period may be calculated that is directly proportional to the complexity score. Alternatively, an image may be simply classified as “simple” or “complex,” a first period being selected for the former and a longer second period being selected for the latter. Non-linear mappings of complexity to display period may also be employed, as those skilled in the art will recognize.

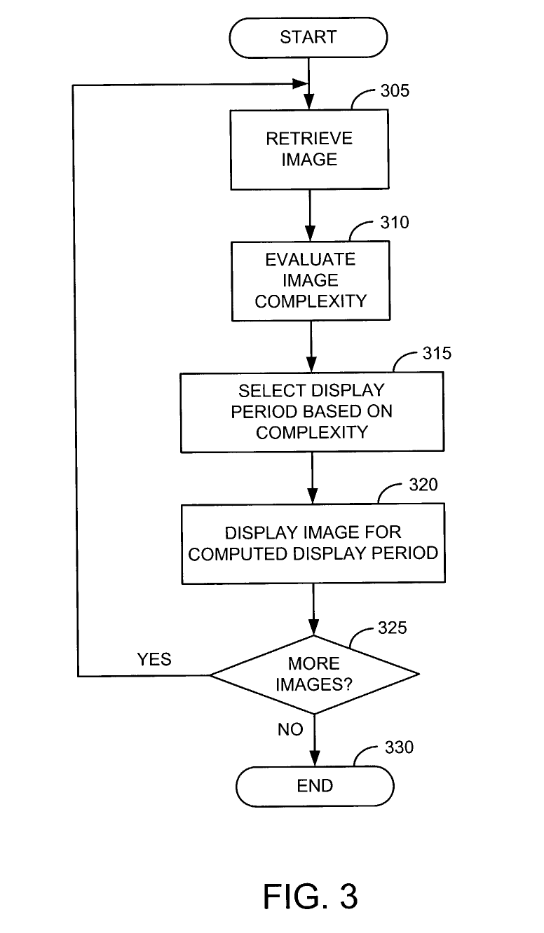

FIG. 3 is a flowchart of the operation of image display system 100 in accordance with an exemplary embodiment of the invention. At 305, an image may be retrieved from image memory 140. At 310, Module “Evaluate Complexity” 150 may be invoked to evaluate the complexity of the retrieved image. At 315, Module “Evaluate Complexity” 150 may select or compute a display period based on the complexity of the image evaluated at 310. Module “Display Timing Control” 155 may be invoked at 320 to cause the image to be displayed on display 130 or projected onto a screen for the period determined at 315. If there are more images to be displayed at 325, control returns to 305. Otherwise, the process terminates at 330.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for displaying an image, comprising:
evaluating the complexity of the image; and
displaying the image for a predetermined period, the predetermined period being dependent on the evaluated complexity of the image.

2. The method of claim 1, wherein the image is one of a sequence of images comprising a slideshow.

3. The method of claim 2, wherein each image in the sequence of images comprising the slideshow is displayed for a time dependent on the evaluated complexity of that image.

4. The method of claim 1, wherein the image is stored in a compressed data file and evaluating the complexity of the image comprises examining the size of the compressed data file.

5. The method of claim 1, wherein evaluating the complexity of the image comprises identifying a feature within the image.

6. The method of claim 5, wherein the feature comprises an image of a person.

7. The method of claim 5, wherein the feature comprises an image of an inanimate object.

8. The method of claim 1, wherein evaluating the complexity of the image comprises examining the frequency content of the image.

9. The method of claim 1, wherein evaluating the complexity of the image comprises detecting at least one edge within the image.

10. The method of claim 1, wherein evaluating the complexity of the image comprises examining the distribution of colors within the image.

11. The method of claim 1, wherein evaluating the complexity of the image comprises analyzing a file name associated with the image.

12. An image display system, comprising:
a memory to store at least one image;
a display;
analysis logic configured to evaluate the complexity of the at least one image; and
control logic configured to show on the display the at least one image for a predetermined period, the predetermined period being dependent on the evaluated complexity of the at least one image.

13. The image display system of claim 12, wherein the at least one image is contained in a compressed data file and the analysis logic is configured to examine the size of the compressed data file.

14. The image display system of claim 12, wherein the analysis logic is configured to identify a feature within the at least one image.

15. The image display system of claim 14, wherein the feature comprises an image of a person.

16. The image display system of claim 14, wherein the feature comprises an image of an inanimate object.

17. The image display system of claim 12, wherein the analysis logic is configured to examine the frequency content of the at least one image.

18. The image display system of claim 12, wherein the analysis logic is configured to detect at least one edge within the at least one image.

19. The image display system of claim 12, wherein the analysis logic is configured to examine the distribution of colors within the at least one image.

20. The image display system of claim 12, wherein the analysis logic is configured to analyze a file name associated with the at least one image.

21. An image display system, comprising:
means for storing at least one image;
display means;
means for evaluating the complexity of the at least one image; and
logic means configured to show on the display means the at least one image for a predetermined period, the predetermined period being dependent on the evaluated complexity of the at least one image.

22. The image display system of claim 21, wherein the at least one image is contained in a compressed data file and the means for evaluating the complexity of the at least one image is configured to examine the size of the compressed data file.

23. The image display system of claim 21, wherein the means for evaluating the complexity of the at least one image is configured to identify a feature within the at least one image.

24. The image display system of claim 23, wherein the feature comprises an image of a person.

25. The image display system of claim 23, wherein the feature comprises an image of an inanimate object.

26. The image display system of claim 21, wherein the means for evaluating the complexity of the at least one image is configured to examine the frequency content of the at least one image.

27. The image display system of claim 21, wherein the means for evaluating the complexity of the at least one image is configured to detect at least one edge within the at least one image.

28. The image display system of claim 21, wherein the means for evaluating the complexity of the at least one image is configured to examine the distribution of colors within the at least one image.

29. The image display system of claim 21, wherein the means for evaluating the complexity of the at least one image is configured to analyze a file name associated with the at least one image.
